(19) United States
(12) Patent Application Publication
(10) Pub. No.: US 2025/0006969 A1
(43) Pub. Date: Jan. 2, 2025

(54) IMPACT ENERGY ATTENUATION SYSTEM FOR A FUEL CELL

(71) Applicant: GM GLOBAL TECHNOLOGY OPERATIONS LLC, Detroit, MI (US)

(72) Inventors: Yeh-Hung Lai, Oakland, MI (US); Mehul M. Vora, Troy, MI (US); Siguang Xu, Rochester Hills, MI (US); Purushothama Siddappaji, Bengaluru (IN)

(73) Assignee: GM GLOBAL TECHNOLOGY OPERATIONS LLC, Detroit, MI (US)

(21) Appl. No.: 18/344,173

(22) Filed: Jun. 29, 2023

(51) Int. Cl. H01M 8/248; H01M 8/0263; H01M 8/0271; H01M 8/04007

(52) U.S. Cl. CPC H01M 8/248; H01M 8/0263; H01M 8/0271; H01M 8/04007; H01M 2250/20

(57) ABSTRACT

A bipolar plate for a fuel cell system includes a rigid plate having a first side defining first passages, a second side defining second passages, a seal bead, and a peripheral edge; and an impact energy attenuation system. The seal bead is arranged proximal to the peripheral edge of the rigid plate, and the impact energy attenuation system is disposed proximal to the peripheral edge. The impact energy attenuation system includes first energy attenuating beads and second energy attenuating beads, wherein each of the first energy attenuating beads has a first compression modulus and a first zero-compression height, and wherein each of the second energy attenuating beads has a second compression modulus and a second zero-compression height. The first compression modulus is greater than the second compression modulus, and the second zero-compression height is greater than the first zero-compression height.

### INTRODUCTION

A fuel cell is an electrochemical device that converts chemical energy of a fuel, e.g., hydrogen, into electrical power by an electro-chemical reaction. The fuel cell includes an anode, a cathode, and an electrolyte that is disposed between the anode and the cathode, and a fuel delivery system that supplies the fuel, e.g., hydrogen to the anode. During operation, fuel, such as hydrogen gas, may enter the anode, and oxygen or air may enter the cathode. The hydrogen gas may dissociate in the anode to generate free hydrogen protons and electrons. The hydrogen protons may then pass through the electrolyte to the cathode, and react with oxygen and electrons in the cathode to generate water. Further, the electrons from the anode may instead be directed through an electrical load to perform work by transforming the electrical power to mechanical power. Multiple fuel cells may be combined to form a fuel cell stack to generate a desired fuel cell power output. For example, a fuel cell for a vehicle may include many stacked fuel cells. One type of fuel cell includes a polymer electrolyte membrane fuel cell (PEMFC).

Fuel cells are used to produce electric energy in vehicles. The electric energy may be stored in a battery and/or directed to a motor to provide a motive force to the vehicle. In a fuel cell, such as a polymer electrolyte membrane fuel cell, an ion-transmissive membrane is sandwiched between a pair of catalyzed electrodes, which are further sandwiched between two gas diffusion layers to form a membrane electrode assembly (MEA). An electrochemical reaction occurs when a first reactant in the form of a gaseous reducing agent such as hydrogen is introduced through a first gas diffusion layer to an anode electrode and ionized. The first reactant is then passed through the ion-transmissive material. After passing through the ion-transmissive material, the first reactant combines with a second reactant in the form of a gaseous oxidizing agent such as oxygen that has been introduced through a second gas diffusion layer to a cathode. The combination of reactants form water. Electrons liberated in the ionization proceed, in the form of DC current, to the cathode via an external circuit that may include a load such as an electric motor.

MEAs may be formed into a stack to form a fuel cell. Adjacent MEAs are separated, one from another, by a series of reactant channels in the form of a gas impermeable bipolar plate. The bipolar plate, in addition to promoting a flow of reactants, also provides support for the stack. Each bipolar plate includes one or more seal beads that prevent reactants from leaving the MEA. During a collision event, leading cells, i.e., those cells closest to a point of impact, experience an effective positive acceleration force and trailing cells, those cells farthest from the point of impact, experience an effective negative acceleration force. Thus, the leading cells tend to experience increasing seal force while the trailing cells tend to experience a decreasing seal force.

As the seal force on the leading cells increases, so does the risk of exceeding an upper sealing limit. Similarly, as the seal force on the trailing seals decreases, so does the risk of falling below a minimum seal force. Exceeding the upper limit or falling below the lower limit of the seal forces may cause seal beads to deform. Deformation of the seal bead impacts the integrity of each cell and may lead to leakage of the first reactant, the second reactant, and/or coolant. Accordingly, it is desirable to provide a fuel cell with an energy attenuating seal bead to improve structural integrity and impact resistance.

### SUMMARY

Disclosed is a bipolar plate for a fuel cell system that includes a rigid plate having a first side defining a first plurality of passages, a second side defining a second plurality of passages, a seal bead, and a peripheral edge; and an impact energy attenuation system. The seal bead is arranged proximal to the peripheral edge of the rigid plate; and the impact energy attenuation system is disposed proximal to the peripheral edge. The impact energy attenuation system includes a plurality of first energy attenuating beads and a plurality of second energy attenuating beads, wherein each of the plurality of first energy attenuating beads has a first compression modulus and a first zero-compression height, and wherein each of the plurality of second energy attenuating beads has a second compression modulus and a second zero-compression height. The first compression modulus is greater than the second compression modulus, and the second zero-compression height is greater than the first zero-compression height.

An aspect of the disclosure may include the plurality of first attenuating beads and the plurality of second attenuating beads project being orthogonal to a plane defined by the rigid plate.

Another aspect of the disclosure may include each of the plurality of first attenuating beads having one of a round shape, a toroidal shape, a rectangular shape, a serpentine shape, an elliptical shape, or a teardrop shape.

Another aspect of the disclosure may include each of the plurality of second attenuating beads having one of a round shape, a toroidal shape, a rectangular shape, a serpentine shape, an elliptical shape, or a teardrop shape.

Another aspect of the disclosure may include the plurality of first attenuating beads and the plurality of second attenuating beads being arranged to combine to compress before reaching a low load bead height for the seal bead.

Another aspect of the disclosure may include the plurality of first energy attenuating beads and the plurality of second energy attenuating beads of the impact energy attenuation system being disposed on the bipolar plate between the seal bead and the peripheral edge.

Another aspect of the disclosure may include the plurality of first energy attenuating beads and the plurality of second energy attenuating beads of the impact energy attenuation system being formed on the bipolar plate between the seal bead and the peripheral edge.

Another aspect of the disclosure may include the plurality of first energy attenuating beads being arranged on the bipolar plate in relation to the plurality of second energy attenuating beads to define a plurality of channels between the seal bead and the peripheral edge of the bipolar plate.

Another aspect of the disclosure may include the plurality of first attenuating beads and the plurality of second attenuating beads being alternately arranged.

Another aspect of the disclosure may include the first plurality of attenuating beads being interposed with the second plurality of attenuating beads.

Another aspect of the disclosure may include the rigid plate being fabricated from one of a metallic or a polymeric material.

Another aspect of the disclosure may include a fuel cell system that includes a plurality of bipolar plate assemblies arranged in a stack, wherein each of the bipolar plate assemblies includes a rigid plate having a first side defining a first plurality of passages, a second side defining a second plurality of passages, a first subgasket, a second subgasket, a seal bead, a peripheral edge, and an impact energy attenuation system. A plurality of coolant passages are defined between the first subgasket and the second subgasket. The seal bead is arranged proximal to the peripheral edge of the rigid plate, and the seal bead is arranged to seal against the first subgasket and the second subgasket. The impact energy attenuation system is disposed proximal to the peripheral edge of the rigid plate. The impact energy attenuation system includes a plurality of first energy attenuating beads and a plurality of second energy attenuating beads. Each of the first energy attenuating beads has a first compression modulus and a first zero-compression height, and each of the second energy attenuating beads has a second compression modulus, and a second zero-compression height. The first compression modulus is greater than the second compression modulus, and the second zero-compression height is greater than the first zero-compression height.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a vehicle, in accordance with the disclosure.

FIG. 2 schematically illustrates a drivetrain for a vehicle that includes a fuel cell, in accordance with the disclosure.

FIG. 3 schematically illustrates a cutaway of a portion of a fuel cell stack assembly, in accordance with the disclosure.

FIG. 4 schematically illustrates an exploded cutaway of a portion of a fuel cell stack assembly, in accordance with the disclosure.

FIG. 5 schematically illustrates a cross-sectional view of an embodiment of the fuel cell stack assembly of FIG. 3 taken at Line 5-5, in accordance with the disclosure.

FIG. 6A schematically illustrates a top view of a portion of a bipolar plate including an impact energy attenuation system, including an expanded top view of a portion of the impact energy attenuation system of the bipolar plate, in accordance with the disclosure.

FIG. 6B schematically illustrates a cutaway cross-sectional sideview of a portion of the impact energy attenuation system of the bipolar plate described with reference to FIG. 6A taken at Line 6A-6A, in accordance with the disclosure.

FIG. 7 graphically illustrates a compression parameter in relation to load for an embodiment of an impact energy attenuation system, in accordance with the disclosure.

FIG. 8 graphically illustrates a deformation parameter in relation to load for an embodiment of an impact energy attenuation system, in accordance with the disclosure.

FIGS. 9A and 9B schematically illustrate detailed cutaway side views of embodiments of an element of an impact energy attenuation system, in accordance with the disclosure.

FIGS. 10A through 10G schematically illustrate top views of various embodiments of elements of an impact energy attenuation system, in accordance with the disclosure.

FIGS. 11A through 11E schematically illustrate side views of various embodiments of elements of an impact energy attenuation system, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely illustrative in nature and is not intended to limit the application and uses. Furthermore, there is no intention to be bound by an expressed or implied theory presented herein. Throughout the drawings, corresponding reference numerals indicate like or corresponding parts and features.

As used herein, the term “system” may refer to one of or a combination of a plurality of mechanical devices that are arranged to provide the described functionality.

The use of ordinals such as first, second and third does not necessarily imply a ranked sense of order, but rather may distinguish between multiple instances of an act or structure.

All numerical values of parameters (e.g., of quantities or conditions) in this specification, including the appended claims, are to be understood as being modified by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

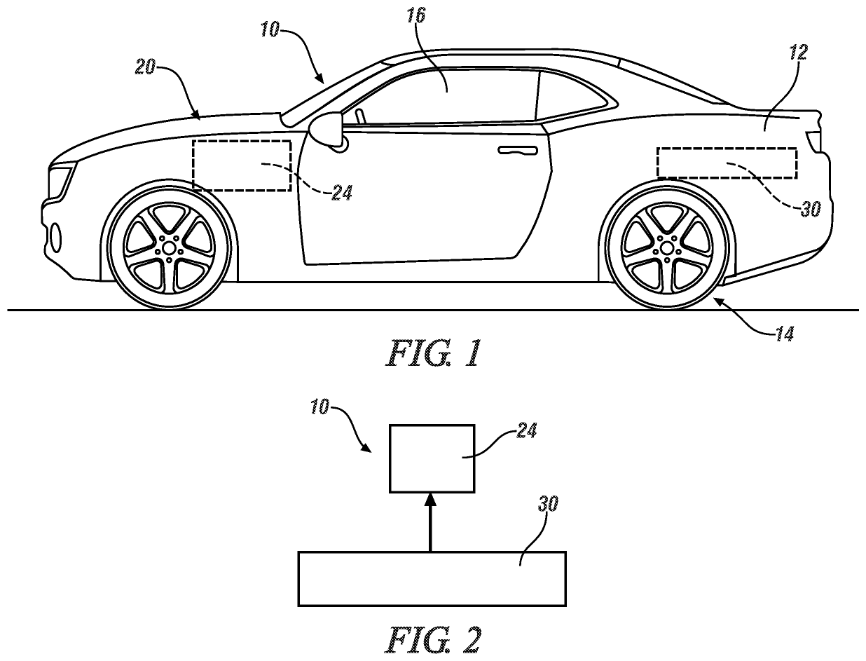

Referring to the drawings, wherein like reference numerals correspond to like or similar components throughout the several Figures, FIG. 1, consistent with embodiments disclosed herein, illustrates a vehicle 10 that employs a fuel cell system 30 as part of a drivetrain. The vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

Vehicle 10 includes a body 12 resting on a plurality of wheels, one of which is indicated at 14. Vehicle 10 includes a passenger compartment 16. A power system 20 is operatively connected to one or more of the plurality of wheels 14. Referring to FIG. 2, power system 20 includes an electric motor 24 connected to a fuel cell system 30. Fuel cell system 30 provides electric power to operate electric motor 24 based on driver inputs. That is, a driver (not shown) seated in passenger compartment 16 may request power be delivered to wheels 14 from electric motor 24.

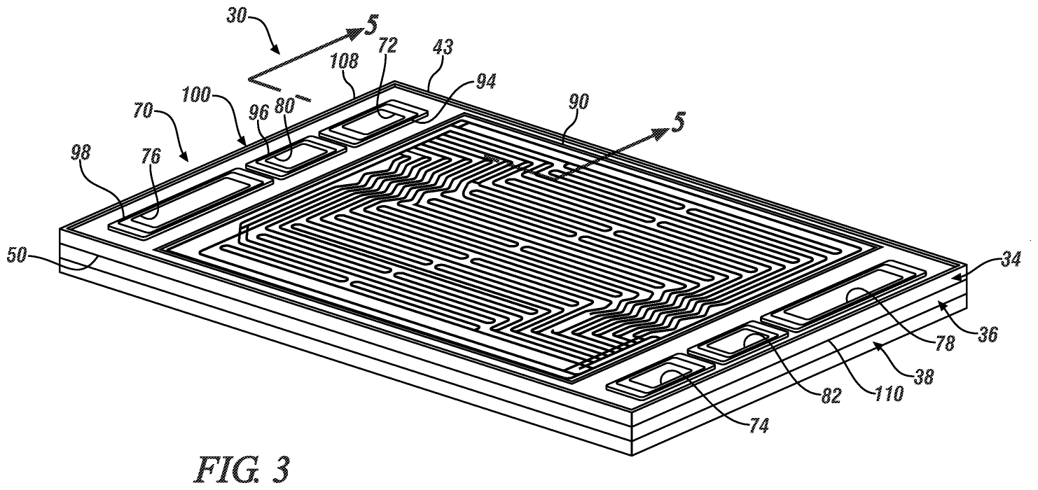

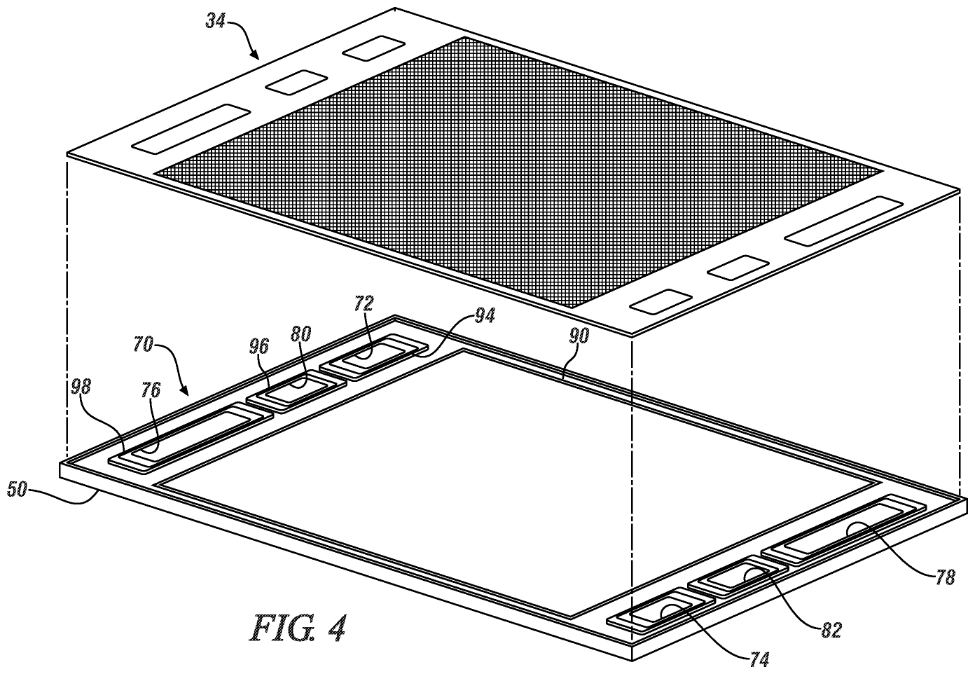

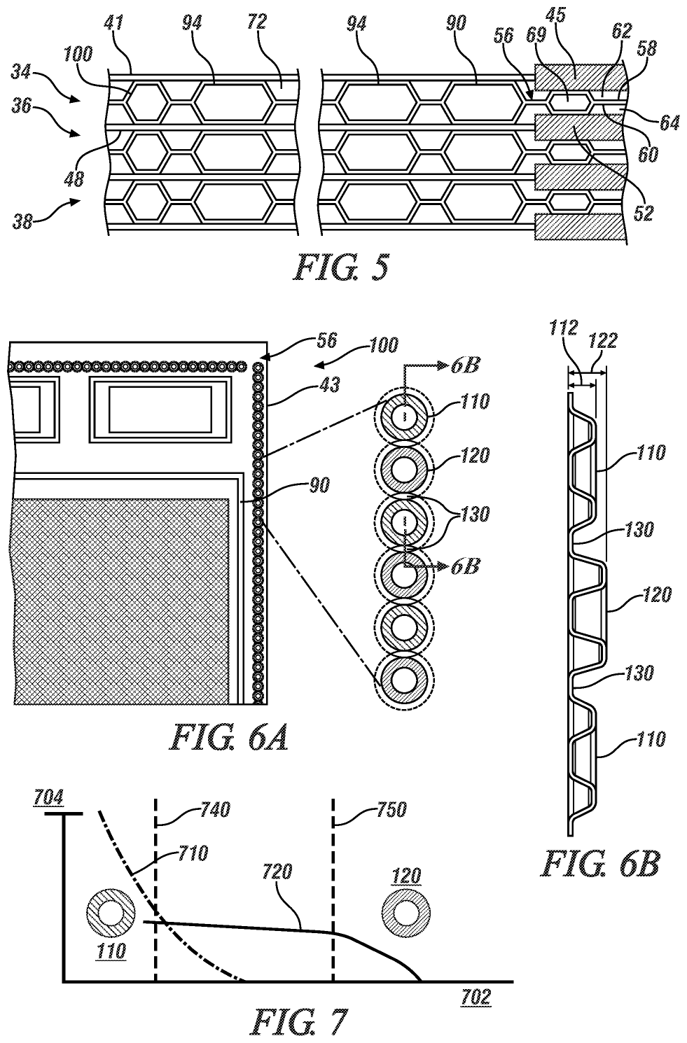

FIGS. 3 and 4 describe fuel cell system 30 in accordance with a nonlimiting example. Fuel cell system 30 is formed from a plurality of stacked and interconnected bipolar plate assemblies including a first bipolar plate assembly 34, a second bipolar plate assembly 36, and a third bipolar plate assembly 38. The number and arrangement of bipolar plate assemblies may vary. Reference will follow to FIG. 5 and with continued reference to FIGS. 3 and 4 in describing first bipolar plate assembly 34 with an understanding that second bipolar plate assembly 36 and third bipolar plate assembly 38 include similar structure.

First bipolar plate assembly 34 includes a first subgasket 41 having a first peripheral edge 43 and a first membrane electrode assembly (MEA) 45. First bipolar plate assembly 34 also includes a second subgasket 48 having a second peripheral edge 50. Second subgasket 48 includes a second MEA 52. As shown in FIG. 5, second subgasket 48 may define a surface of second bipolar plate assembly 36, and may also define a surface of first bipolar plate assembly 34. A bipolar plate 56 is positioned between first subgasket 41 and second subgasket 48. Bipolar plate 56 includes a first side 58 that defines a cathode side (not separately labeled) and a second side 60 that defines an anode side (also not separately labeled). The bipolar plate 56 is a rigid plate that is fabricated from metal by stamping. Alternatively, the bipolar plate 56 is a rigid plate that is fabricated from a polymer by injection molding or another process.

Bipolar plate 56 includes a plurality of corrugations (not separately labeled) that form a first plurality of passages 62 on first side 58. First plurality of passages 62 may contain a first reactant or cathode fluid (not shown) that is in contact with a surface (not separately labeled) of first MEA 45. The corrugations also form a second plurality of passages 64 at second side 60. A second plurality of passages 64 may contain a second reactant or anode fluid (not shown) that is in contact with a surface (also not separately labeled) of second MEA 52. Bipolar plate 56 also includes a plurality of coolant passages 69 that may contain a coolant that absorbs heat from fuel cell system 30.

In further accordance with a non-limiting example, bipolar plate 56 includes a plurality of headers 70 that fluidically communicate with first plurality of passages 62, second plurality of passages 64, and coolant passages 69. More specifically, plurality of headers 70 include a first reactant inlet 72 and a first reactant outlet 74. Plurality of headers 70 also includes a second reactant inlet 76 and a second reactant outlet 78. Further, plurality of headers may include a coolant inlet 80 and a coolant outlet 82.

Bipolar plate 56 is further shown to include a perimeter seal bead 90 that extends entirely around first MEA 45, second MEA 52, as well as first plurality of passages 62, second plurality of passages 64, and coolant passages 69. Further each of the plurality of headers 70 includes an associated header seal bead such as shown at 94, 96, and 98 in connection with first reactant inlet 72, coolant inlet 80, and second reactant inlet 76. For example, seal bead 94 extends entirely about first reactant inlet 72, seal bead 96 extends entirely about coolant inlet 80, and seal bead 98 extends entirely about second reactant inlet 76. Seal beads 90, 94, 96, and 98 are disposed between first subgasket 41 and second subgasket 48. Seal bead 90 extends about first bipolar plate assembly 34. In this manner, seal bead 90 fluidically isolates the first bipolar plate assembly 34 from ambient. Seal beads 90, 94, 96, and 98 ensure fluid isolation between the first reactant 72, the second reactant 76, and coolant 80 and/or ambient air.

During a collision event, seal bead integrity may be compromised. It is desirable to provide a fuel cell with an energy attenuating seal bead to improve sealing integrity and collision resistance of fuel cell seal by having the same effect without changing the dimensions and the design of fuel cell seal.

Therefore, in accordance with a non-limiting example, the first bipolar plate assembly 34 also includes an embodiment of an impact energy attenuation system 100 that is designed to absorb acceleration forces so that seal beads 90, 94, 96, and 98 maintain sealing integrity during, for example, a collision event. In a nonlimiting example, impact energy attenuation system 100 may include a first section 108 that extends about a first portion (not separately labeled) of first peripheral edge 43 and a second section that extends about a second portion (also not separately labeled) of first peripheral edge 43.

In a non-limiting example, seal beads 90, 94, 96, and 98 are formed from a first material having a first stiffness and the impact energy attenuation system 100 is formed as described herein with additional stiffnesses that are greater than the first stiffness. Stiffness is understood to be defined as an amount of vertically applied compressive force required for unit displacement [nm] of seal bead deformation per unit length of seal bead [mm].

FIGS. 6A and 6B show a portion of an embodiment of the bipolar plate 56 of the first bipolar plate assembly 34 including one embodiment of the impact energy attenuation system 100. The impact energy attenuation system 100 is disposed between the seal bead 90 and the peripheral edge 43. The impact energy attenuation system 100 includes a plurality of first energy attenuating beads (first beads) 110 and a plurality of second energy attenuating beads (second beads) 120, wherein the first beads 110 and the plurality of second beads 120 project orthogonal to a plane defined by the bipolar plate 56. As shown, the first beads 110 and the plurality of second beads 120 are arranged in a row proximal to the peripheral edge 43. In one embodiment, the plurality of first beads 110 and the plurality of second beads 120 are arranged in alternating fashion, with a plurality of fluidic channels 130 arranged therebetween. The purpose of the plurality of fluidic channels 130 is to facilitate and enable leak detection in the event of a rupture of one of the seal beads 90, 94, 96, and 98.

Each of the first beads 110 has a first compression modulus and a first zero-compression height 112, and each of the second beads 120 has a second compression modulus and a second zero-compression height 122, wherein the second zero-compression height 120 is greater than the first zero-compression height 110. Furthermore, the first compression modulus associated with the first beads 110 is greater than the second compression modulus associated with the second beads 120. Stated another way, the first beads 110 are stiffer but shorter than the second beads 120.

In one embodiment, the first beads 110 and the second beads 120 are configured in toroidal shapes, as depicted, with the first beads 110 being stiffer but shorter than the second beads 120.

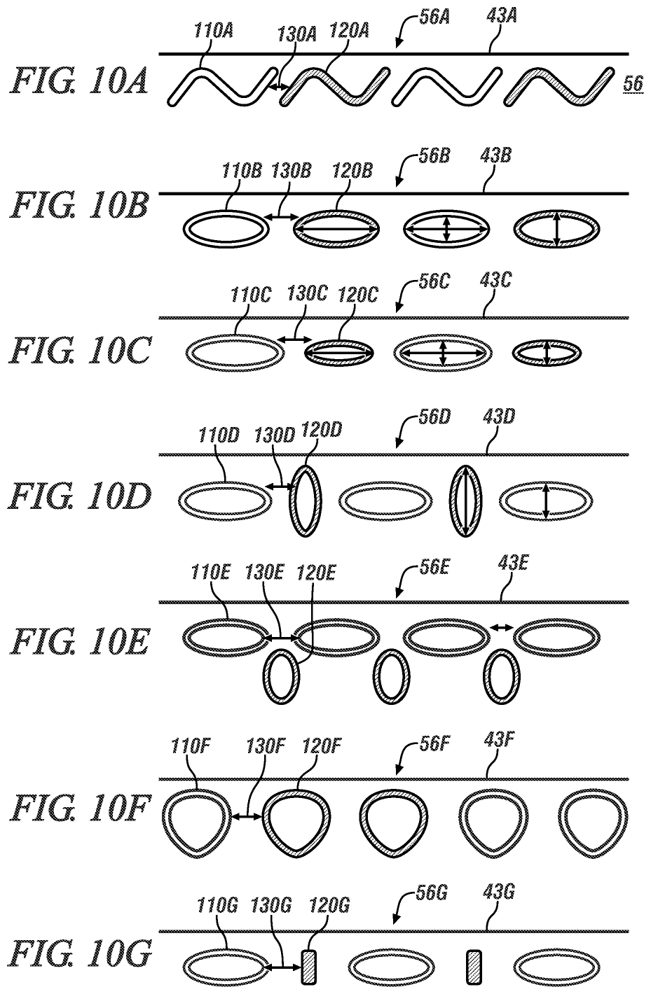

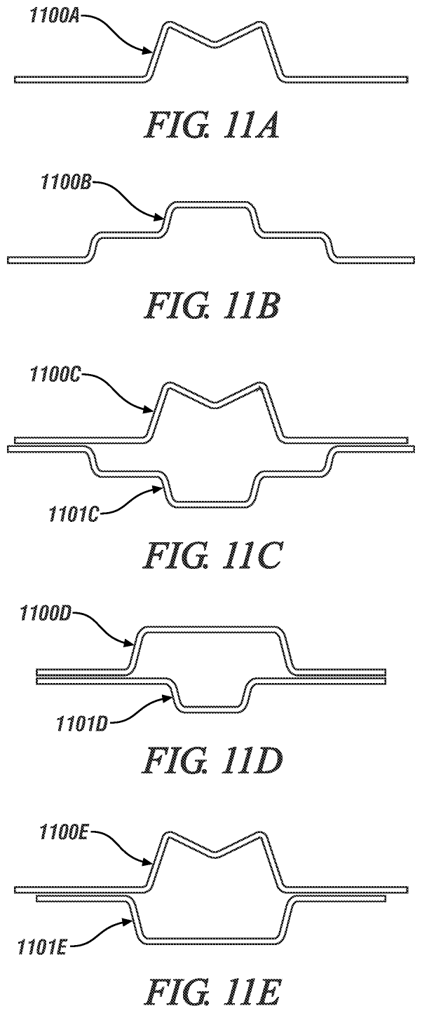

Alternatively, the first beads 110 and the second beads 120 may be configured in other shapes, examples of which are illustrated with reference to FIGS. 10A through 10G and FIGS. 11A through 11E, with the first beads 110 being stiffer but shorter than the second beads 120.

Furthermore, although not explicitly illustrated, it is contemplated that embodiments of the impact energy attenuation system 100 disposed between the seal bead 90 and the peripheral edge 43 may include a plurality of first energy attenuating beads, a plurality of second energy attenuating beads, and a plurality or third, fourth, fifth, or more energy attenuating beads arranged proximal to the peripheral edge 43, wherein the first energy attenuating beads are stiffer but shorter than the second energy attenuating beads, which in turn are stiffer but shorter than the third energy attenuating beads, which in turn are stiffer but shorter than the fourth energy attenuating beads, etc.

In one embodiment, and as shown, each of the plurality of first beads 110 has a first compression modulus or seal force to achieve a first stiffness, and each of the plurality of second beads 120 has a second compression modulus to achieve a second stiffness, wherein the first compression modulus is greater than the second compression modulus.

FIG. 7 graphically illustrates an embodiment of the first compression modulus 710 associated with the first bead 110 in relation to the second compression modulus 720 associated with the second bead 120, with compression height 702 being depicted on the horizontal axis in relation to compression load 704, which is depicted on the vertical axis. As illustrated and as designed, the first compression modulus 710 associated with the first bead 110 overlaps the second compression modulus 720 associated with the second bead 120 within a range between a high load bead height 740 and a low load bead height 750.

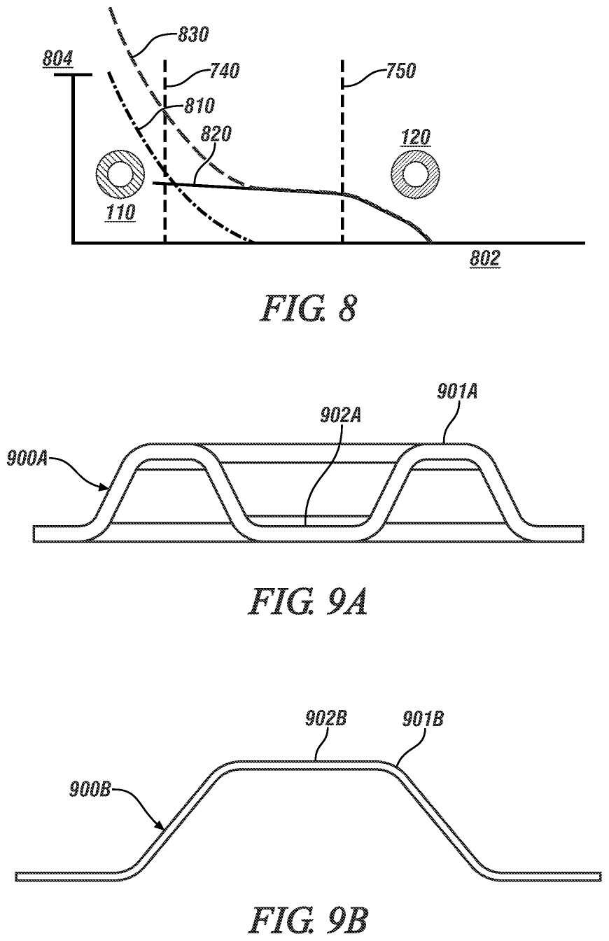

FIG. 8 graphically illustrates compressed bead height 802 in relation to compression load 804 for a system employing an embodiment of the first beads 110 and the second beads 120. Line 810 shows deformation for the first beads 110, and Line 820 shows deformation for the second beads 120. By combining the first beads 110 and the second beads 120 into an embodiment of the impact energy attenuation system 100 on the bipolar plate 56 of the first bipolar plate assembly 34, the impact energy attenuation system 100 achieves deformation line 830, which enables impact energy attenuation and absorption over a broad range without resulting in exceeding an upper limit or falling below a lower limit of the seal beads 90, 94, 96, and 98 in the case of leading and trailing cells, respectively. Avoiding exceeding an upper limit or falling below a lower limit of the seal beads 90, 94, 96, and 98 advantageously avoids or minimizes leakage. Due to combined possibilities of MEA thickness tolerance and seal bead height tolerance, an assembled stack has seal beads 90, 94, 96, and 98 that may be compressed within the range between the high load bead height 740 and the low load bead height 750. For the impact energy attenuating bead to alleviate unloading in the trailing seal during a collision event in the case when the seal bead is assembled at the low load bead height 750, the first attenuating beads 110 and the plurality of second attenuating beads 120 are advantageously arranged to combine to compress before reaching a low load bead height for the seal bead. Furthermore, for the impact energy attenuating bead to alleviate the over loading in the leading seal during a collision event in the case when the seal bead is assembled at the high load bead height 740, the first attenuating beads and the plurality of second attenuating beads are advantageously arranged to combine to compress before reaching a high load bead height for the seal bead.

In one embodiment, each of the second beads 120 achieves the second compression modulus by being arranged with a relatively tall projection from the surface of the bipolar plate 56. In one embodiment, each of the first beads 110 achieves the first compression modulus by being arranged with a relatively short projection from the surface of the bipolar plate 56 that is orthogonal to a plane defined by the rigid plate of the bipolar plate 56.

In one embodiment, and as shown, each of the plurality of first beads 110 and the plurality of second beads 120 are formed by molding or deforming the material of the bipolar plate 56 orthogonal to a plane defined by the rigid plate.

Alternatively, each of the plurality of first beads 110 and the plurality of second beads 120 are formed by applying materials capable of providing support to the bipolar plate 56, wherein the materials are configured to provide the requisite first and second compression moduli.

FIGS. 9A and 9B schematically illustrate cutaway side views of embodiments of one of the first beads 100. FIG. 9A schematically illustrates a cutaway side view of first energy attenuating bead 900A having a dimpled shape with a raised outer portion 901A and a depressed inner portion 902A. FIG. 9B schematically illustrates a cutaway side view of first energy attenuating bead 900B with a raised shape with a raised inner portion 901B and a raised outer portion 902B.

FIGS. 10A through 10G schematically illustrate top views of various embodiments of arrangements, placements, and dimension-related sizes of the first and second beads 110, 120, with intervening channels 130, on a surface of bipolar plate 56, in relation to the first peripheral edge 43. In each of the embodiments described and illustrated with reference to FIGS. 10A through 10G, the plurality of first beads 110 has a first compression modulus or seal force to achieve a first stiffness, and the plurality of second beads 120 has a second compression modulus to achieve a second stiffness, wherein the first compression modulus is greater than the second compression modulus. Furthermore, the plurality of first beads 110 has a first compression modulus and a first zero-compression height, and the plurality of second beads 120 has a second compression modulus and a second zero-compression height, wherein the second zero-compression height is greater than the first zero-compression height. Furthermore, the first compression modulus associated with the first beads 110 is greater than the second compression modulus associated with the second beads 120. Stated another way, of the first beads 110 are stiffer but shorter than the second beads 120. Furthermore, although first beads 110 and second beads 120 are illustrated and described, it is appreciated that some embodiments may further include third beads, and some embodiments may further include third and fourth beads, etc., in accordance with the concepts described herein.

FIG. 10A schematically illustrates a top view of an embodiment of arrangements, placements, and dimension-related sizes of the first and second beads 110A, 120A, with intervening channels 130A, on a surface of bipolar plate 56A, in relation to the first peripheral edge 43A, wherein the first and second beads 110A, 120A are arranged in serpentine shapes.

FIG. 10B schematically illustrates a top view of an embodiment of arrangements, placements, and dimension-related sizes of the first and second beads 110B. 120B, with intervening channels 130B, on a surface of bipolar plate 56B, in relation to the first peripheral edge 43B, wherein the first and second beads 110B, 120B are arranged in elliptical shapes, with major axes that are parallel to the first peripheral edge 43B. Dimensional sizes of the first and second beads 110B, 120B and channel 130B may be equivalent, as shown with reference to FIG. 10B. In one embodiment, the major axes of the first and second beads 110B, 120B are equidistant from the first peripheral edge 43B. In one embodiment, the elliptical shapes have a dimpled configuration, i.e., have raised outer portion and a depressed inner portion, analogous to that which is shown in FIG. 9A. In one embodiment, the elliptical shapes have a raised shape, analogous to that which is shown in FIG. 9B.

FIG. 10C schematically illustrates a top view of an embodiment of arrangements, placements, and dimension-related sizes of the first and second beads 110C. 120C, with intervening channels 130C, on a surface of bipolar plate 56C, in relation to the first peripheral edge 43C, wherein the first and second beads 110C, 120C are arranged in elliptical shapes, with major axes that are parallel to the first peripheral edge 43C. Dimensional sizes of the first and second beads 110C, 120C and channel 130B may vary. In one embodiment, the major axes of the first and second beads 110B, 120B are equidistant from the first peripheral edge 43C. In one embodiment, the elliptical shapes have a dimpled configuration, i.e., have raised outer portion and a depressed inner portion, analogous to that which is shown in FIG. 9A. In one embodiment, the elliptical shapes have a raised shape, analogous to that which is shown in FIG. 9B.

FIG. 10D schematically illustrates a top view of an embodiment of arrangements, placements, and dimension-related sizes of the first and second beads 110D, 120D, with intervening channels 130D, on a surface of bipolar plate 56D, in relation to the first peripheral edge 43D, wherein the first and second beads 110D, 120D are arranged in elliptical shapes, with first major axes associated with the first beads 110D being parallel to first peripheral edge 43D, and with second major axes associated with the second beads 120D being orthogonal to first peripheral edge 43D. In alternative embodiments, the first major axes associated with the first beads 110D may be skewed left, or skewed right, or alternatingly skewed left and right in relation to the first peripheral edge 43D.

FIG. 10E schematically illustrates a top view of an embodiment of arrangements, placements, and dimension-related sizes of the first and second beads 110E, 120E, with intervening channels 130E, on a surface of bipolar plate 56E, in relation to the first peripheral edge 43E, wherein the first beads 110E are arranged in elliptical shapes, with major axes that are parallel to the first peripheral edge 43E, and the second beads 120E are arranged in elliptical shapes, with major axes being perpendicular to the peripheral edge 43E and offset from the first peripheral edge 43E in relation to the first beads 110E. Alternatively, one or both of the first beads 110E and the second beads 120E may be configured to have circular shapes.

FIG. 10F schematically illustrates a top view of an embodiment of arrangements, placements, and dimension-related sizes of the first and second beads 110F, 120F, with intervening channels 130F, on a surface of bipolar plate 56F, in relation to the first peripheral edge 43F, wherein the first and second beads 110F, 120F are arranged in teardrop shapes having a rounded end and an opposed vertex. As shown, the vertices of the first and second beads 110F, 120F are arranged to face away from the first peripheral edge 43F as shown. Alternatively, the vertices of the first and second beads 110F, 120F may be arranged to face leftward relative to the first peripheral edge 43F, arranged to alternate in facing leftward and rightward relative to the first peripheral edge 43F, or arranged to alternate in facing towards and away from the first peripheral edge 43F. In one embodiment, the teardrop shapes have a dimpled configuration, i.e., have raised outer portion and a depressed inner portion, analogous to that which is shown in FIG. 9A. In one embodiment, the teardrop shapes have a raised shape, analogous to that which is shown in FIG. 9B.

FIG. 10G schematically illustrates a top view of an embodiment of arrangements, placements, and dimension-related sizes of the first and second beads 110G, 120G, with intervening channels 130G, on a surface of bipolar plate 56G, in relation to the first peripheral edge 43G, wherein the first beads 110G are arranged in elliptical shapes, with major axes that are parallel to the first peripheral edge 43G, and the second beads 120G are arranged in rectangular shapes, with major axes that are orthogonal to the first peripheral edge 43G.

FIGS. 11A through 11E schematically illustrate various sideview arrangements of embodiments of the first and second beads 110, 120, including a dimpled bead 1100A (FIG. 11A), a multi-stepped bead 1100B (FIG. 11B), an opposed asymmetric bead including dimpled bead 1100C facing a multi-stepped bead 1101C (FIG. 11C), a combination of opposed concave beads including a first concave bead 1100D facing a second concave bead 1101D having different diameters (FIG. 11D), and a combination of opposed concave and dimpled beads including dimpled bead 1100E facing concave bead 1101E (FIG. 11E).

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A bipolar plate for a fuel cell system, the bipolar plate comprising:
a rigid plate having a first side defining a first plurality of passages, a second side defining a second plurality of passages, a seal bead, and a peripheral edge; and
an impact energy attenuation system;
wherein the seal bead is arranged proximal to the peripheral edge of the rigid plate; and
wherein the impact energy attenuation system is disposed proximal to the peripheral edge;
wherein the impact energy attenuation system includes a plurality of first energy attenuating beads and a plurality of second energy attenuating beads;
wherein each of the plurality of first energy attenuating beads has a first compression modulus and a first zero-compression height;
wherein each of the plurality of second energy attenuating beads has a second compression modulus and a second zero-compression height;
wherein the second zero-compression height is greater than the first zero-compression height; and
wherein the first compression modulus is greater than the second compression modulus.

2. The bipolar plate of claim 1, wherein the plurality of first energy attenuating beads and the plurality of second energy attenuating beads project orthogonal to a plane defined by the rigid plate.

3. The bipolar plate of claim 2, wherein each of the plurality of first energy attenuating beads has one of a round shape, a toroidal shape, a rectangular shape, a serpentine shape, an elliptical shape, or a teardrop shape.

4. The bipolar plate of claim 2, wherein each of the plurality of second energy attenuating beads has one of a round shape, a toroidal shape, a rectangular shape, a serpentine shape, an elliptical shape, or a teardrop shape.

5. The bipolar plate of claim 2, wherein the plurality of first energy attenuating beads have a round shape.

6. The bipolar plate of claim 1, wherein the plurality of first energy attenuating beads and the plurality of second energy attenuating beads are arranged to combine to compress before reaching a low load bead height for the seal bead.

7. The bipolar plate of claim 1, wherein the plurality of first energy attenuating beads and the plurality of second energy attenuating beads of the impact energy attenuation system are disposed on the bipolar plate between the seal bead and the peripheral edge.

8. The bipolar plate of claim 1, wherein the plurality of first energy attenuating beads and the plurality of second energy attenuating beads of the impact energy attenuation system are formed on the bipolar plate between the seal bead and the peripheral edge.

9. The bipolar plate of claim 8, wherein the plurality of first energy attenuating beads are arranged on the bipolar plate in relation to the plurality of second energy attenuating beads to define a plurality of channels between the seal bead and the peripheral edge of the bipolar plate.

10. The bipolar plate of claim 1, wherein the plurality of first energy attenuating beads and the plurality of second energy attenuating beads are alternately arranged.

11. The bipolar plate of claim 1, wherein the first plurality of energy attenuating beads are interposed with the second plurality of energy attenuating beads.

12. The bipolar plate of claim 1, wherein the rigid plate is fabricated from one of a metallic or a polymeric material.

13. A fuel cell system, comprising:
a plurality of bipolar plate assemblies arranged in a stack;
wherein each of the bipolar plate assemblies includes a rigid plate having a first side defining a first plurality of passages, a second side defining a second plurality of passages, a first subgasket, a second subgasket, a seal bead, a peripheral edge, and an impact energy attenuation system;
wherein a plurality of coolant passages are defined between the first subgasket and the second subgasket;
wherein the seal bead is arranged proximal to the peripheral edge of the rigid plate, and wherein the seal bead is arranged to seal against the first subgasket and the second subgasket;
wherein the impact energy attenuation system is disposed proximal to the peripheral edge of the rigid plate,
wherein the impact energy attenuation system includes a plurality of first plurality of energy attenuating beads and a plurality of second energy attenuating beads;
wherein each of the first energy attenuating beads has a first compression modulus and a first zero-compression height;
wherein each of the second energy attenuating beads has a second compression modulus and a second zero-compression height;
wherein the second zero-compression height is greater than the first zero-compression height; and
wherein the first compression modulus is greater than the second compression modulus.

14. The fuel cell system of claim 13, wherein the plurality of first energy attenuating beads and the plurality of second energy attenuating beads project orthogonal to a plane defined by the rigid plate.

15. The fuel cell system of claim 14, wherein each of the plurality of first energy attenuating beads has one of a round shape, a toroidal shape, a rectangular shape, a serpentine shape, an elliptical shape, or a teardrop shape, and wherein each of the plurality of second energy attenuating beads has one of a round shape, a toroidal shape, a rectangular shape, a serpentine shape, an elliptical shape, or a teardrop shape.

16. The fuel cell system of claim 13, wherein the plurality of first energy attenuating beads and the plurality of second energy attenuating beads combine to compress before reaching a low load bead height for the seal bead.

17. The fuel cell system of claim 13, wherein the plurality of first energy attenuating beads and the plurality of second energy attenuating beads of the impact energy attenuation system are disposed on the bipolar plate between the seal bead and the peripheral edge of the bipolar plate.

18. The fuel cell system of claim 13, wherein the plurality of first energy attenuating beads are arranged on the bipolar plate in relation to the plurality of second energy attenuating beads to define a plurality of channels between the seal bead and the peripheral edge of the bipolar plate.

19. A bipolar plate for a fuel cell system, the bipolar plate comprising:
a rigid plate having a first side defining a first plurality of passages, a second side defining a second plurality of passages, and a peripheral edge; and
an impact energy attenuation system;
wherein the impact energy attenuation system is disposed proximal to the peripheral edge;
wherein the impact energy attenuation system includes a plurality of first energy attenuating beads and a plurality of second energy attenuating beads;
wherein each of the plurality of first energy attenuating beads has a first compression modulus and a first zero-compression height; and
wherein each of the plurality of second energy attenuating beads has a second compression modulus and a second zero-compression height; and
wherein the second zero-compression height is greater than the first zero-compression height.

20. The bipolar plate of claim 19, wherein the plurality of first energy attenuating beads and the plurality of second energy attenuating beads project orthogonal to a plane defined by the rigid plate; wherein each of the plurality of first energy attenuating beads has one of a round shape, a toroidal shape, a rectangular shape, a serpentine shape, an elliptical shape, or a teardrop shape; and wherein each of the plurality of second energy attenuating beads has one of a round shape, a toroidal shape, a rectangular shape, a serpentine shape, an elliptical shape, or a teardrop shape.
